(19) United States
(12) Patent Application Publication
(10) Pub. No.: US 2009/0037808 A1
(43) Pub. Date: Feb. 5, 2009

(54) System, Method and Computer Program Product for Producing and Managing Certain Documents

(76) Inventor: Barbara L. Thibodeau, Agawam, MA (US)

Correspondence Address: Barbara L.Thibodeau, 525 Suffield Street, Agawam, MA, 01001, US

(21) Appl. No.: 12/184,335

(22) Filed: Aug. 1, 2008

Related U.S. Application Data
(60) Provisional application No. 60/953,286, filed on Aug. 1, 2007.

(51) Int. Cl. G06F 17/21

(52) U.S. Cl. 715/235

(57) ABSTRACT

A system, method and computer program product for a user to produce certain template documents and track the progress of the transfer of an Intellectual Property portfolio. This system, method and computer program product comprises a processor in communication with one or more storage device, where the user would input specific data regarding an Assignee and Assignor, and the bibliographic information regarding the Intellectual Property. The inputted Intellectual Property information is sorted by country. Using the stored inputted information along with the stored template documents, the computer program product generates certain template documents per country. The template documents meet all the legal requirements of that country, listing all of the transferable properties, to affect a transfer of rights.

### CROSS-REFERENCE TO RELATED APPLICATION

This application claims the benefit of US Provisional Application Ser. No. 60/953,286, filed 01 Aug. 2007, which is incorporated herein in its entirety.

### BACKGROUND

The process of transferring the Intellectual Property (IP) rights after an acquisition or merger from one entity to another is very complex and time consuming. If you are not familiar with the process and the pitfalls you or your client can lose time, money and rights associated with the IP Portfolio while navigating all the laws and procedural issues that arise during such a transfer.

Intellectual Property, or IP, has been historically known as the group of legal rights to things people create or invent. Intellectual Property rights typically include patent, copyright, trademark and trade secret rights. An Intellectual Property (IP) Portfolio is defined as all of the Intellectual Property owned by one entity.

IP portfolios are now being used in many different manners. Portfolios are being used for collateral for loans and are the backbone of many business acquisitions. Unfortunately, in current practice, companies and banks are buying or loaning monies to companies that do not own the properties in the portfolio. The companies are completing sales before they are analyzing the properties and are finding many of the properties abandoned, close to expiration, have assignment encumbrances or the company does not even own the property they are selling due to typographical errors or procedural missteps.

There is a need for a system and method to categorize an IP portfolio and to transfer the identified portfolio, from one entity to another, in a streamlined manner thus reducing the cost associated and the time it takes to transfer the properties in domestic and foreign patent offices and ensure all properties are transferred in accordance to each countries Intellectual Property laws. There is a need for a system and method to put all the acquired assets in one storage device that contains variables that can be applied when the user answers a series of questions which will then produce the necessary documents and instructions to affect the transfer and track the progress of the properties and produce accurate and timely reports as to the status of the transfer.

There are many different types of databases and time management systems available, but none that put all of these variables together in one system and method to create a streamlined process to guide a user through the process in a logical manner, which will save the user time, money and preserve the intellectual property rights they have acquired.

There are also many different methodologies in searching or categorizing the portfolio which is to be bought or sold through different type of database searches by terms such as Assignee, Inventor or classification but there is nothing to direct the actions of the person transferring the portfolio after the acquisition is complete.

### SUMMARY

The present invention relates to production and management of certain documents using template documents, user inputted and stored data and certain international and United States laws and procedures to transfer Intellectual Property from one entity to another.

The present invention begins with a user accessing the computer program product on a host computer. The computer program product begins with the user answering questions about the Assignor and Assignee companies, e.g., legal address, signer names, etc. The responses are saved into a storage device. The user then enters a US Patent or Trademark number that is stored into a storage device. The next user interface screen directs the user to choose which foreign countries the US Patent or Trademark have been filed in, if any. The next user interface screen shows a table of the selected foreign countries and directs the user to add the foreign property numbers. This information is saved into a storage device.

This stored information is then categorized per country and is inputted into stored template documents that are legally compliant for each particular country entered. Once the template documents are generated the user is directed to print a document package which contains, the requisite template documents required to transfer the properties in compliance with each countries laws and procedures, an instructional user guide that contains directions for completing the documents and template form cover letters to send with the documents to the different places they need to go.

When the user begins to complete necessary actions, the user accesses the computer program product and checks off the completed actions whereas the computer program product then directs the user to print a next set of form documents or complete the next required action until all actions are completed, thus successfully transferring the properties.

### DETAILED DESCRIPTION

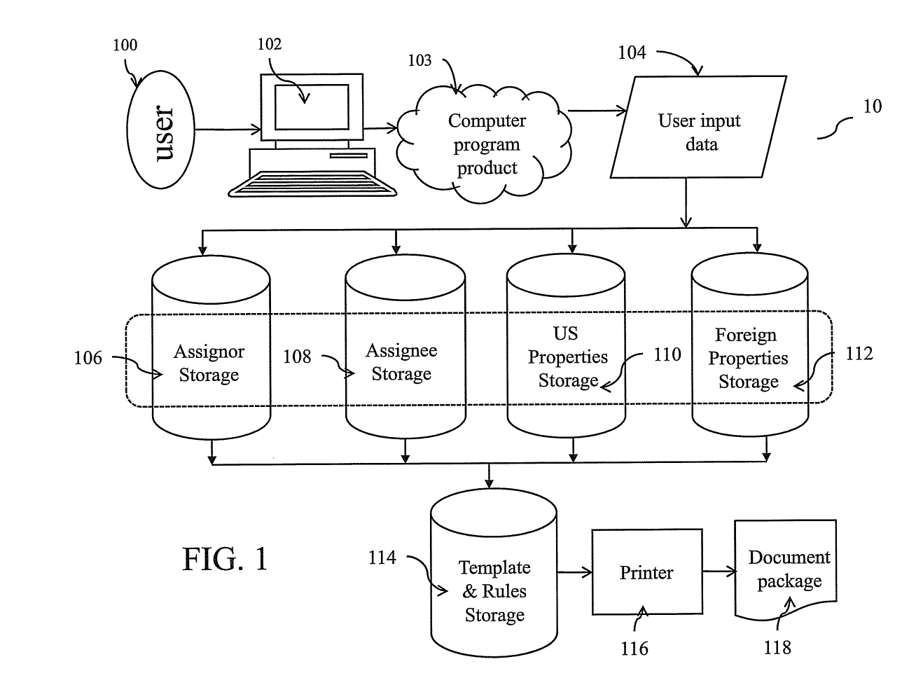

FIG. 1, is a schematic diagram of the exemplary system architecture of the present invention.

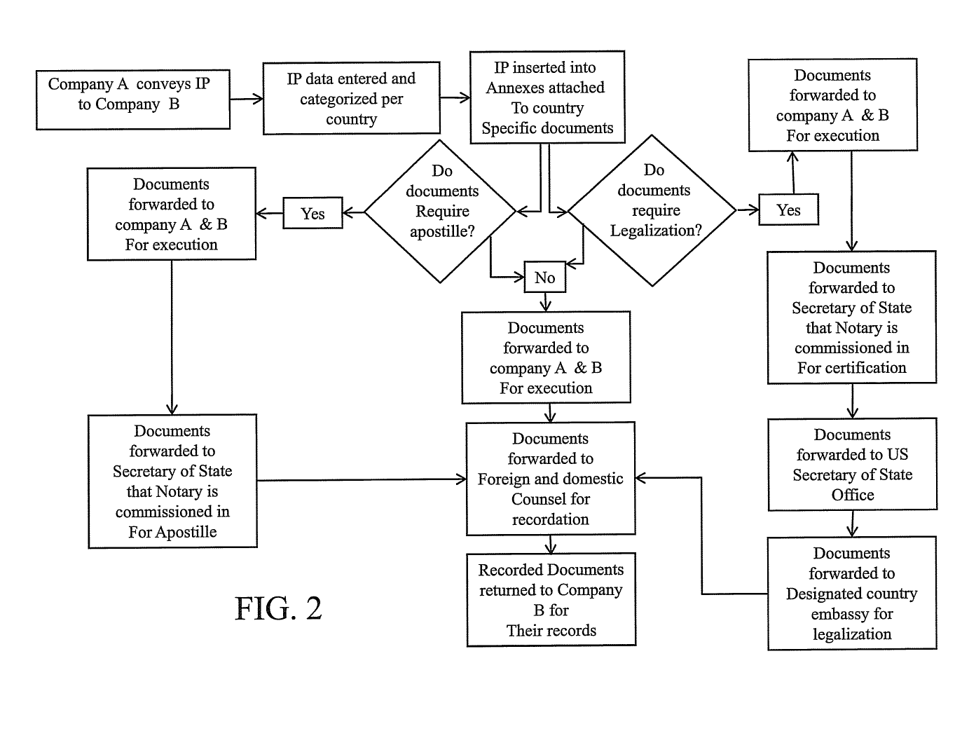

FIG. 2, is a flow diagram of an exemplary process and method, implemented by the information entered by the user.

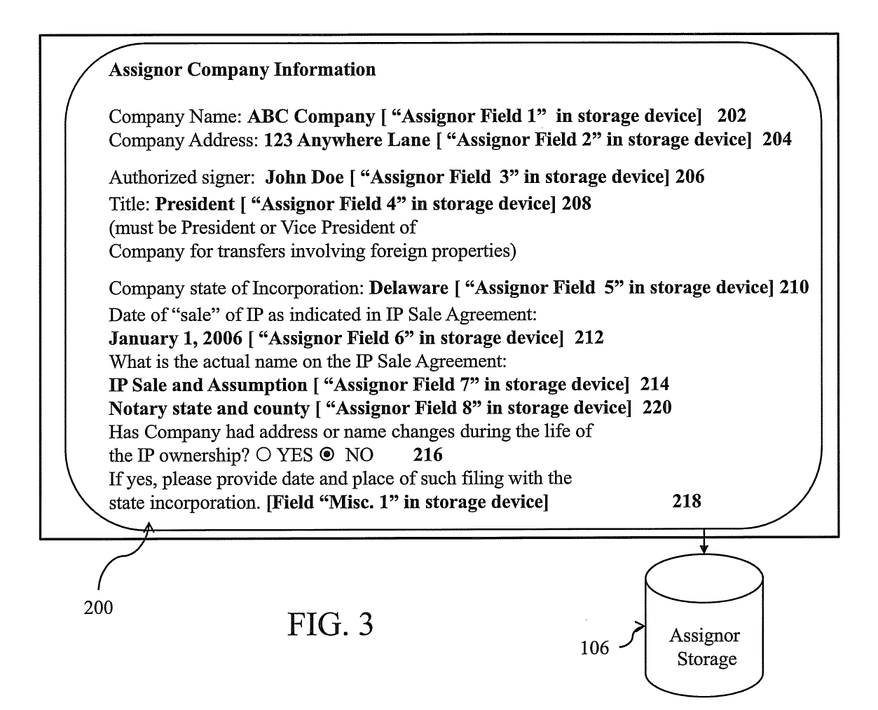

FIG. 3, is an exemplary user interface screen for adding information about the Assignor involved in the IP portfolio transfer and a storage device which stores the user inputted information.

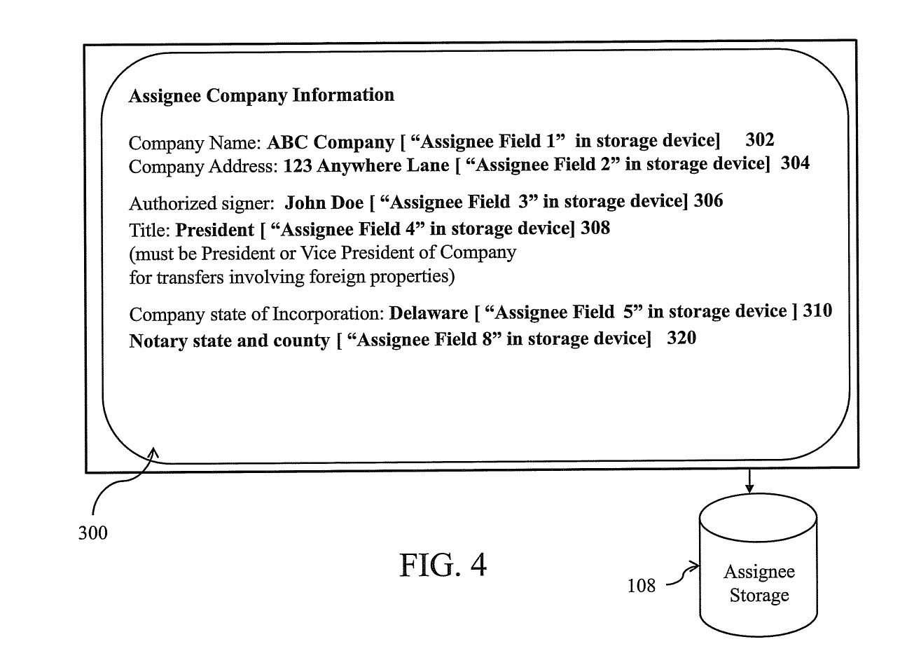

FIG. 4, is an exemplary user interface screen for adding information about the Assignee involved in the IP portfolio transfer and a storage device which stores the user inputted information.

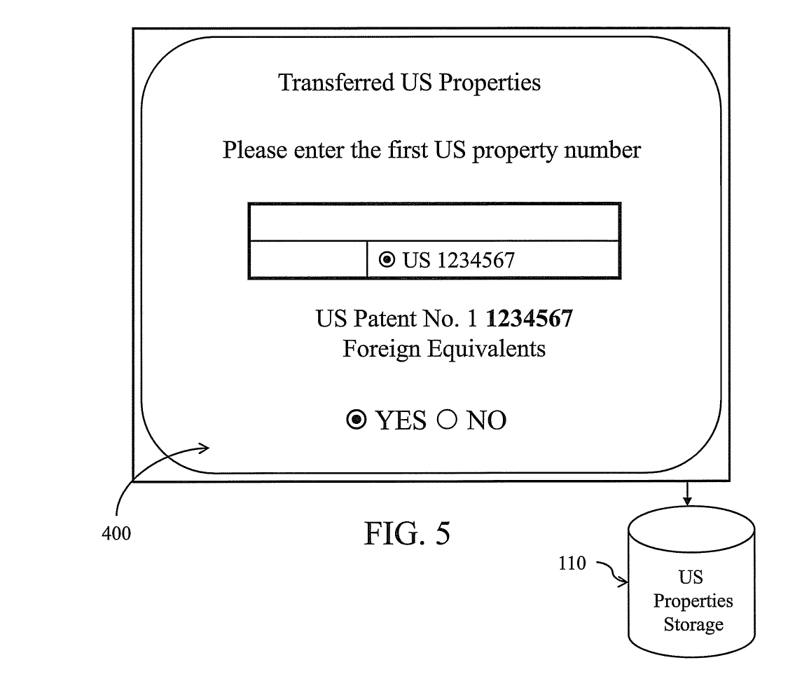

FIG. 5 is an exemplary user interface screen for adding information about the properties to be transferred in the IP portfolio and a storage device that stores the user inputted information.

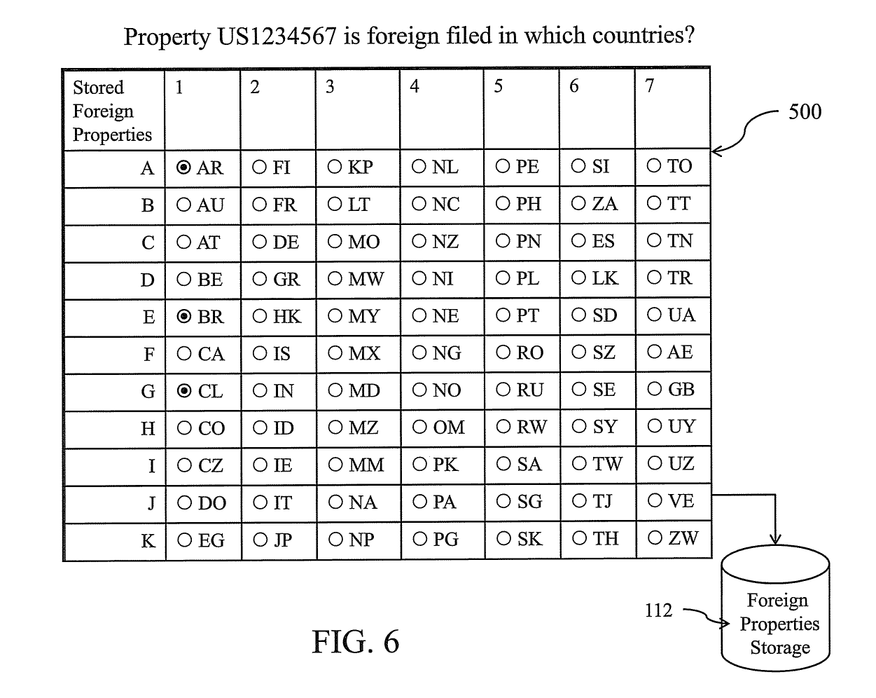

FIG. 6 is an exemplary user interface screen for selecting foreign countries that a property is filed in and a storage device that stores the user inputted information.

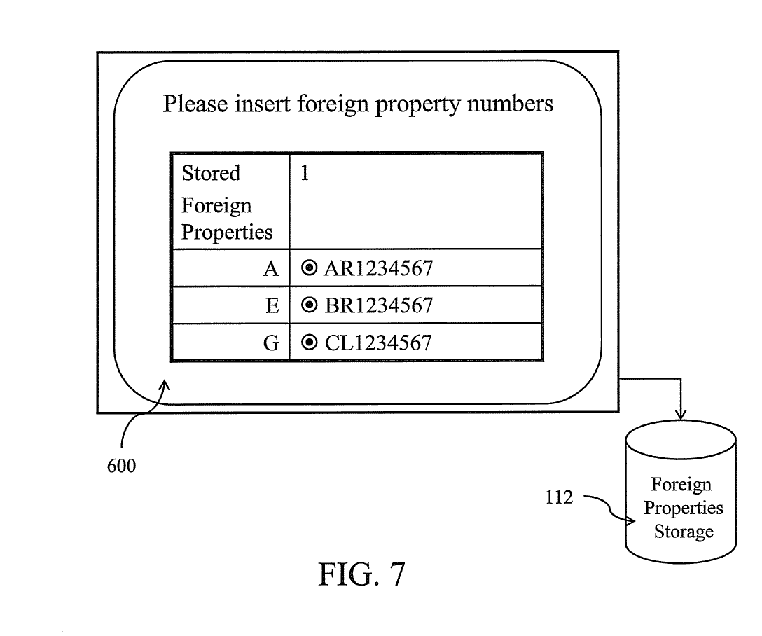

FIG. 7 is an exemplary user interface screen for adding application, patent and registration numbers for the properties in each of the user selected foreign countries and a storage device that stores the user inputted information.

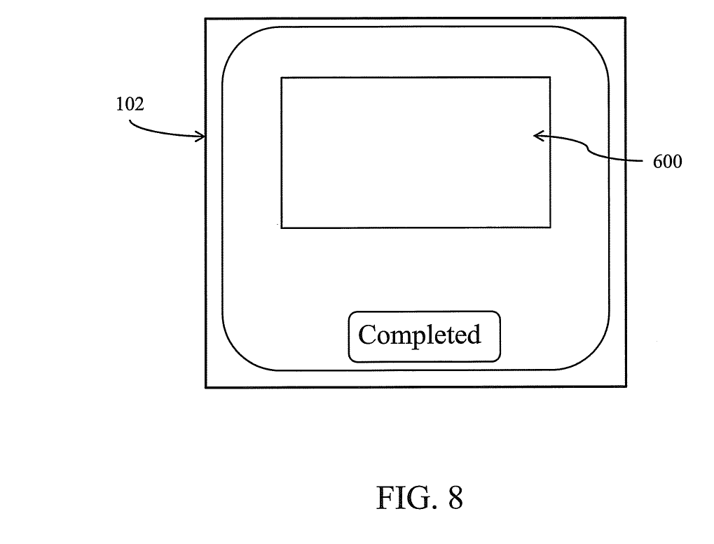

FIG. 8 is an exemplary user interface screen for indicating the user inputted information is complete.

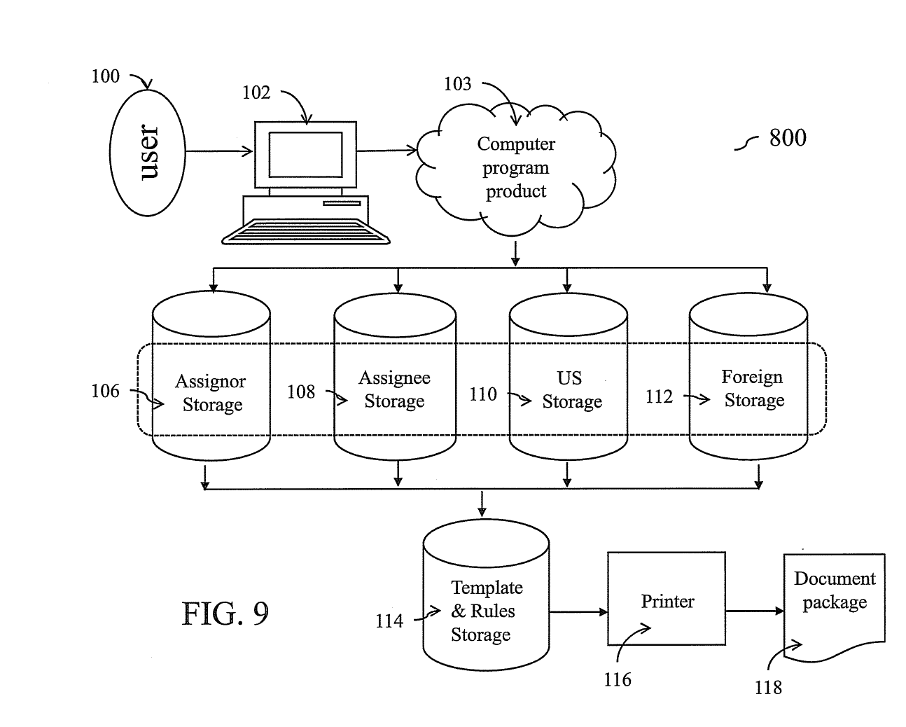

FIG. 9 is a block diagram illustrating one exemplary method of the present invention accessing the separate storage devices, sorting the application, patent and registration numbers by country, selecting the proper documents for each country and inputting the stored information into the required documents.

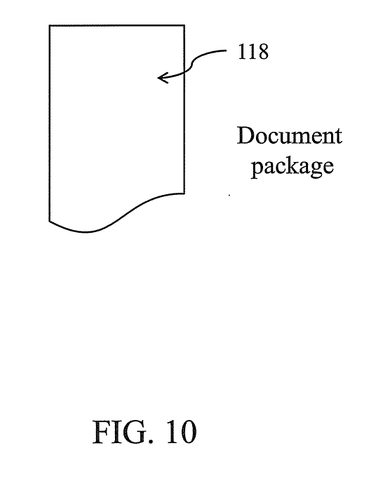

FIG. 10 is a document package.

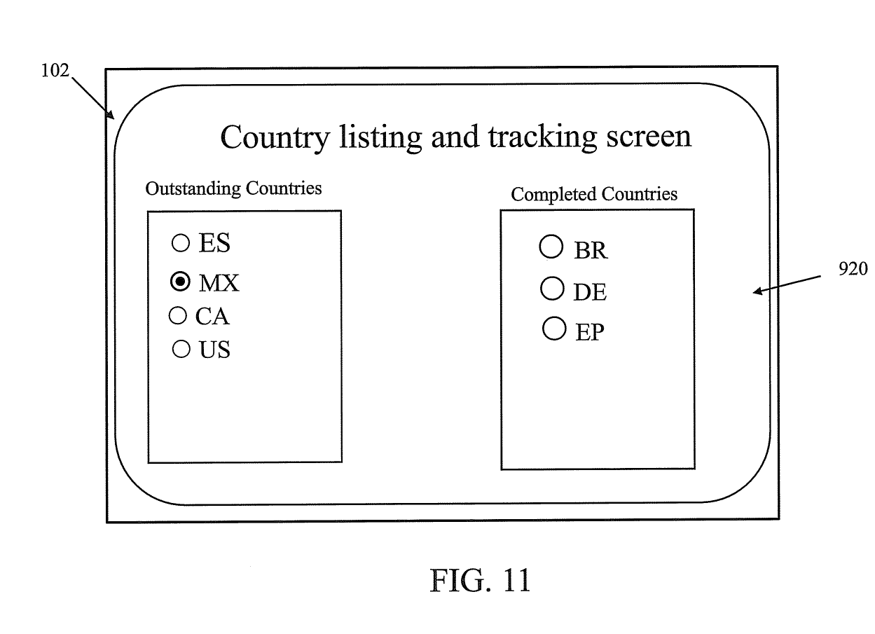

FIG. 11 is an exemplary country listing tracking user interface screen where the user can view all countries that have a remaining outstanding actions and countries that have been completed.

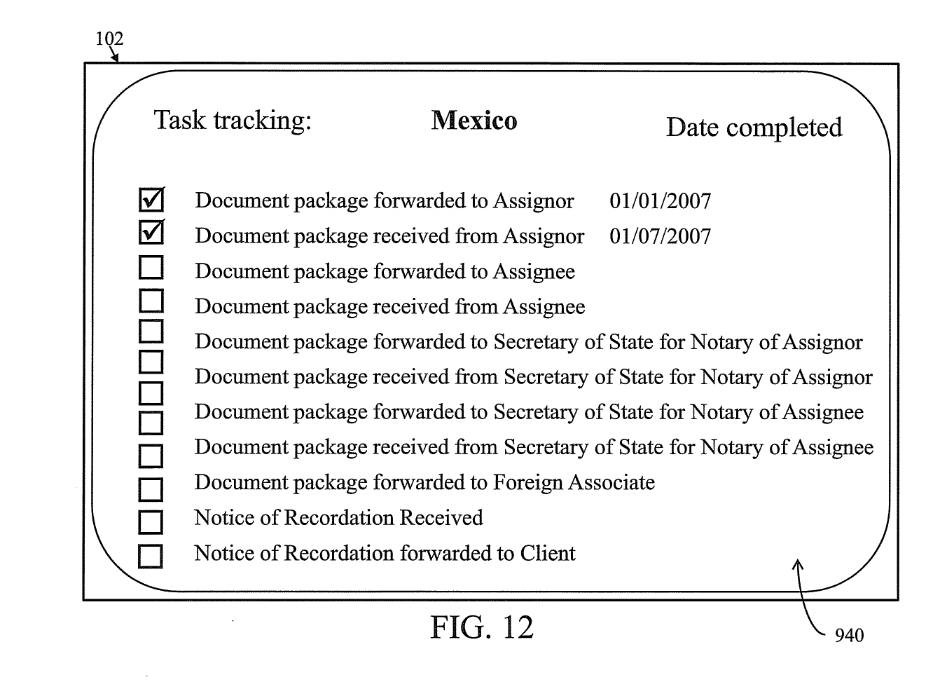

FIG. 12 is an exemplary task management user interface screen for each country that shows which actions are completed and which actions are still pending.

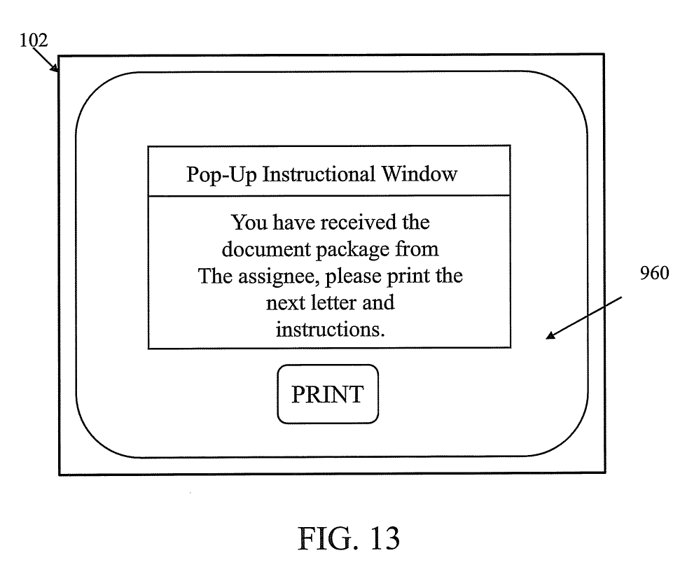

FIG. 13 is an exemplary user interface instructional pop up window directing the user on any next action that may be required.

### DETAILED DESCRIPTION

The following is a description of the figures and the preferred embodiments relating to the present invention.

This particular computer program product is to be used after both companies have performed their due diligence on the properties to be transferred. The companies should have already determined that they own the properties to be transferred and that the properties are still in force. The objective of the computer program product is to make preparing the final documents needed to transfer the properties with instructions that are easy to follow and comprehensive for the person transferring the properties.

A system, method and computer program product for producing certain documents to transfer an IP portfolio is generally described at 10 in FIG. 1.

In FIG. 1, the user 100 accesses a host system 102, which can be a stand-alone unit or used with a network system. The host system 102 may comprise any type of processor device capable of handling the product. Although the computer program product shown at 10 in FIG. 1 to be executing directly on the host system 102, it will be appreciated and understood by those skilled in the art that the computer program product 103 may be executed by a remote processor (e.g., a general-purpose computer in communication with 103 the host system via a network.) The user 100 launches the computer program product 103 and then is prompted to input data 104. The computer program product 103 sorts the data and stores it in the appropriate storage devices 106, 108, 110, 112 on the host system 102. It is understood that the storage devices 106, 108, 110, 112 could be housed in one storage device, but for clarification, we will refer to each of the devices as a separate unit.

Once the user 100 has completed inputting the data, the computer program product 103 sorts the information and transfers the information into predefined fields of form template documents that are contained in the template and rules storage device 114. This can be completed using the principals of any type of mail merge process that is also known in the art. The user 100 is then directed to use a printer 116 to print a document package 118.

The host system 102 should run an operating system that can support one or more applications. The host system 102 also has memory to store the information in storage devices 106, 108, 110, 112, which is known in the art. Host system 102 may be in direct communication with one or all storage devices 106, 108, 110, 112 via cabling or wireless local network technologies, for example, or may be linked to one or all storage devices 106, 108, 110, 112 via wide area network (WAN), Internet, or another type of network implementation. The computer program product 103, which can be written onto a media or stored directly to the host system's 102 hard drive, can interact directly with the host system's 102 memory or a separate physical device to implement the present invention's applications.

FIG. 2, is a flow diagram of an exemplary process and method, implemented by the question and answer information entered by the user 100 into the computer program product 103. The process and method will be further defined throughout the specification.

FIG. 3, is the initial exemplary user interface screen 200 where the user 100 begins inputting information regarding the Assignor Company. Assignor Field 1 202 prompts the user 100 to input the Assignor Company name. Assignor Field 2 204 prompts the user 100 to input the Assignor Company address. Assignor Field 3 206 prompts the user 100 to input the person who will sign the documents on behalf of the Assignor Company. Assignor Field 4 208 prompts the user 100 to input the title of person signing the documents on behalf of the company. The user interface screen 200 will prompt the user 100 to make sure the person signing the documents is either a President or Vice President of the company. This is important in regards to some of the document requirements of different foreign countries. Assignor Field 5 210 prompts the user 100 to input the state of incorporation of the Assignor Company. Assignor Field 6 212 prompts the user 100 to input the official “date of sale” of the intellectual property per the sale agreement. Assignor Field 7 214 prompts the user 100 to input what the actual name on the IP Sale Agreement is, for example, IP Sale and Assumption. This is important in regards to some of the document requirements of different foreign countries.

Assignor Field 8 220 prompts the user 100 to input the state and county of a notary who will notarize the signature of the Assignor Company. This will prompt the population of several different fields, template documents and instructional user guides. For example, if there are foreign properties to be assigned in Mexico the assignment template will need an “apostille”. Mexico is a participant of “The Hague convention section 12, Convention abolishing the requirement of legalization” (hereinafter referred to as The Hague convention), which abolishes the need for the hindering process of “legalization” of documents, that some countries still participate in. The answer the user 100 inputs for this field will generate the appropriate notarial certificate (which can change statutory language from state to state and even county to county within a state) that will accompany the assignment template when a document package 118 is printed. The instructional user guide that is printed with the document package 118 will instruct the user 100 to forward the completed executed template documents (with assignor, assignee and notary signatures) to the appropriate Secretary of State office with the appropriate template cover letter and fee (which also varies from state to state.) The information, regarding state and county request procedure, fees and mailing instructions would be saved per state/county in the template and rules storage device 114.

Assignor Field 8 220 will also drive information, documents and instructions for countries that are not a part of The Hague convention.

For Example, Brazil is not a party to The Hague convention. The completed documents to be filed in Brazil first need to be notarized with the appropriate language depending on which state the Notary is commissioned in. Secondly, these documents need to be forwarded to the Secretary of State's office that the Notary is commissioned in with the appropriate cover letter and fee so the documents can be “certified”. Thirdly, these documents need to be forwarded to the US Department of State's office with the appropriate cover letter and fee for certification. Fourthly, these documents need to be forwarded to the foreign embassy of Brazil for “legalization”. After this long process the documents will then be ready for forwarding to your preferred foreign counsel in Brazil for recording. This process is outlined in FIG. 2.

Countries have different embassies located in different regions of the United States. In which state the Notary is commissioned, will dictate which embassy the documents need to be forwarded to. For example, if the Notary is commissioned in Utah, the Brazilian foreign embassy that would legalize the documents is in California. The combination of Assignor Field 8 220 and the template and rules storage device 114 will dictate which notarial certificate, cover letter and instructional user guide will be generated.

Assignor Field Misc. 1 216 prompts the user 100 to answer a YES or NO question regarding whether or not the company has changed its name during the life of the patent. If the user 100 answers NO the user 100 is directed to the next user interface screen. If the user 100 answers YES they will be directed to Misc. Field 1 218 which prompts the user 100 to obtain a copy of the change of name and or company merger as it may be needed to bring the property up to the current name of the company. Certain countries will require this document to be legalized or notarized in the same manner that the other template documents are. Assignor Field 5 210 and the template and rules storage device 114 will then dictate if the documents need legalization or not and will generate the requisite template documents and instructional user guide.

The instructional user guide will aid the user in regards to information such as, fees, payment requirements or restrictions, and mailing requirements, etc. For example, some embassies will only accept bank checks where other embassies will accept company checks or credit card payments.

FIG. 4, is the second user interface screen 300 where the user 100 begins inputting information regarding the Assignee Company that is stored in the Assignee storage device 108. Assignee Field 1 302 prompts the user 100 to input the Assignee Company name. Assignee Field 2 304 prompts the user 100 to input the Assignee Company address. Assignee Field 3 306 prompts the user 100 to input the person who will sign the documents on behalf of the Assignee Company. Assignee Field 4 308 prompts the user 100 to input the title of person signing the documents on behalf of the company. The user interface screen will prompt the user 100 to make sure the person signing the documents is either a President or Vice President of the company. This is important in regards to some of the document requirements of different foreign countries. Assignee Field 5 310 prompts the user 100 to input the state of incorporation of the Assignee Company.

Assignee Field 8 320 prompts the user 100 to input the state and county of a notary who will notarize the signature of the Assignee Company. This will prompt several different fields, required documents and instructional user guide as explained above.

FIG. 5 shows the next user interface screen 400 that asks the user 100 to input the first US property involved in the transfer. This property will be stored in the US properties storage device 110.

The system then asks if the US property has been foreign filed. If the user 100 answers NO they will continue to input US property numbers to be stored in US properties storage device 110 until they answer YES.

FIG. 6 shows a table 500 of all the countries (figure is a sampling) that the property can be foreign filed in with a “radio dial” next to the two-letter country code. The user 100 can then select the foreign countries that the US property is filed in.

FIG. 7 shows a smaller table of the two letter codes for each of the foreign countries the user 100 has selected as having a foreign counterpart that needs to be transferred. The user 100 then enters the properties numbers (e.g., application no., registration no. etc.) associated with the foreign properties, per country, to be transferred. This information is stored in the foreign property storage device 112 which will be grouped and sorted, per country, and inserted into the stored template documents, i.e., assignment, power of attorney, etc., that are needed to transfer property rights in that particular country.

The user 100 will continue to add the US and foreign property information until all of the intellectual property has been added. Once the user 100 selects “completed”, as shown at FIG. 8, the present invention computer program product 103 will access the templates and rules storage device 114 and the different storage devices 106, 108, 110, 112 to merge all of the information into the proper areas of the requisite template documents to process the required documents, cover letters and instructional user guide.

When the computer program product 103 finishes preparing the template documents as prescribed by the template and rules storage device 114, the user 100 is instructed to use either a stand-alone or network printer 116 to print a document package 118 as shown at FIG. 10.

The document package 118 includes the required template documents for transferring the Intellectual Property rights in each country, a template cover letter and an instructional user guide.

Once the user 100 sends the document package to the Assignee or completes a required action, the user 100 would access the host system 102 and the computer program product 103 to view the country listing and tracking user interface screen 920 as shown at FIG. 11. This country listing and tracking user interface screen 920 will help the user track which countries still have actions that need to be taken or which countries have completed all requisite actions to compel a successful transfer of rights from one entity to another. This country listing and tracking user interface screen 920 will also be helpful for the user 100 to quickly determine which properties in which countries have been completely transferred into the name of the Assignee or which properties still have pending actions and remain in the name of the Assignor. This information tends to be difficult to track when a user 100 has multiple countries (or even multiple client portfolios) to monitor that are at different stages of the transfer process. There are some foreign Intellectual Property offices that are severely delayed due to political turmoil, lack of technological advances, and even environmental factors.

The user 100 would select a country that they have completed an action in. A country task-tracking user interface screen 940, shown at FIG. 12, would open showing the user 100 all of the actions that need to be taken to complete that particular country and which actions have already been completed. Some lists will be longer than others due to that countries particular requirements (e.g., legalization or apostille requirements).

The user 100 would check the box that corresponds with the action taken. The computer program product 103 will automatically generate the date the user 100 checks the box or the user 100 can manually override the date if the perform date precedes the current date the user 100 is inputting the information.

Once a completion date is generated for a prescribed action, the computer program product 103 will produce the next set of template documents needed to continue the transfer process. The computer program product 103 will generate a “pop-up” instructional window 960, as shown at FIG. 13, instructing the user 100 to print the next set of required template documents and instructional user guide, if needed.

The user 100 will continue with all remaining countries and actions for each country until all actions are completed. Once a country has all actions completed, that country will shift to the completed country list on the country listing and tracking user interface screen 920. Once all countries are completed, the user 100 has successfully transferred the rights from one entity to the other.

1. A system, method and computer program product for a user to produce certain template documents and track the progress of the transfer of an Intellectual Property portfolio, comprising:
a processor in communication with one or more storage devices;
inputting specific data regarding an Assignee and Assignor;
inputting bibliographic information regarding the Intellectual Property; wherein
the inputted Intellectual Property information is sorted per country; and
using the stored inputted information and stored template documents to generate certain template documents per country, that meet all the legal requirements of that country, listing all of the transferable properties to affect a transfer of rights.

2. The method of claim 1 wherein the template document production uses the user inputted information and stored template documents to generate requisite documents from the inputted information.

3. The method of claim 1 wherein the template document production further relies on the State and county that a Notary Public is commissioned in.

4. The method of claim 1 wherein the template document production further relies on selected foreign countries and their Intellectual Property laws and procedures.

5. The method of claim 1 wherein the user inputted information and stored template documents produces cover letters.

6. The method of claim 1 wherein the user inputted information and stored template documents produces an instructional user guide.

7. A system, method and computer program product for a user to track the progress of the actions and produce additional requisite template documents needed to affect the transfer of an Intellectual Property portfolio, comprising:
a processor in communication with at least two storage devices;
accessing a country listing and tracking user interface screen;
selecting pre-defined options per country; wherein
the selected options and stored template documents generate the next set of template documents that meet all the legal requirements of that country to affect a transfer of rights.

8. The method of claim 7 wherein the template document production uses the user inputted information, stored template documents and country and action selection to generate additional requisite documents.

9. The method of claim 7 wherein the template document production further relies on the state and county that a Notary Public is commissioned in.

10. The method of claim 7 wherein the document production further relies on the selected countries.

11. The method of claim 7 wherein the user inputted information and stored template documents produces template cover letters.

12. The method of claim 7 wherein the user inputted information and stored template documents produces an instructional user guide.
